(19) United States
(12) Patent Application Publication
(10) Pub. No.: US 2003/0118747 A1
(43) Pub. Date: Jun. 26, 2003

(54) Method for producing coatings, adhesive layers or sealing systems for primed or unprimed substrates

(76) Inventors: Rainer Blum, Ludwigshafen (DE); Reinhold Schwalm, Wachenheim (DE); Oskar Stephan, Hockenheim (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/181,437

(22) PCT Filed: Jan. 25, 2001
(86) PCT No.: PCT/EP01/00445

(30) Foreign Application Priority Data
Feb. 2, 2000 (DE) 10004495.6

(51) Int. Cl. B05D 3/06

(52) U.S. Cl. 427/557; 427/385.5

(57) ABSTRACT

The invention relates to a method for producing coatings, adhesive layers or sealing systems for primed or unprimed substrates. The inventive method comprises the following steps: applying to and/or introducing into the substrate (1) coating substances, adhesive substances and/or sealing compounds that contain a component (A) which comprises in the statistical average at least one group (a) with at least one bond per molecule that can be activated by actinic radiation in the form of (1.1) a water-free and solvent-free liquid or melt, (1.2) a powder, (1.3) a dispersion or a solution in at least one organic solvent, or (1.4) in an aqueous medium, (2) drying the layer from a dispersion or solution (1.3) or (1.4) or allowing the resulting layer of the melt (1.1) to solidify or maintaining it in the molten state by heating, (3) melting the solid layer (1.2), (1.3) or (1.4) by heating, and (4) curing the liquid layer resulting from process step (1) or the molten layer resulting from process step (2) or (3) in the molten state, during solidification and/or after solidification with radiation in the near infrared range.

The present invention relates to a novel process for producing coatings, adhesive films or seals for primed or unprimed substrates from free-radically and/or ionically curable coating materials, adhesives or sealing compounds by irradiation. The present invention further relates to the primed or unprimed substrates which carry at least one coating, adhesive film and/or seal produced by the novel process.

Free-radically and/or ionically curable coating materials, adhesives, and sealing compounds, but especially coating materials, which comprise at least one constituent (A) containing on average per molecule at least one group (a) containing at least one bond which can be activated with actinic radiation, and also the constituents (A) per se, have been known for a long time and are described in numerous patents. By way of example, reference is made to the European patents EP 0 928 800 A1, 0 636 669 A1, 0 410 242 A1, 0 783 534 A1, 0 650 978 A1, 0 650 979 A1, 0 650 985 A1, 0 540 884 A1, 0 568 907 A1, 0 054 505 A1, and 0 002 866 A1, the German patents DE 197 09 467 A1, 42 03 278 A1, 33 16 593 A1, 38 36 370 A1, 24 36 186 A1, and 20 03 579 B1, the international patent applications WO 97/46549 and 99/14254, and the American patents U.S. Pat. No. 4,675,234 A1, 4,634,602 A1, 4,424,252 A1, 4,163,810 A1, 4,129,488 A1, and 3,974,303 A1. The known coating materials may be present in the form of water-free and solvent-free liquids and melts (known as 100% systems), powders, or in the form of dispersions or solutions in at least one organic solvent. The same applies to the known adhesives and sealing compounds.

By actinic radiation, here and below, is meant electromagnetic radiation such as visible light, UV radiation or X-rays, but especially UV radiation, and corpuscular radiation such as electron beams. Owing to the relative simplicity of apparatus involved in UV curing, use is made above all of coating materials, adhesives, and sealing compounds which can be cured with UV radiation.

Considered by themselves, coating materials, adhesives and sealing compounds which are curable with UV radiation lead to particular advantages, such as a short cycle time, low energy consumption for curing, and the possibility of coating, bonding, and sealing heat-sensitive substrates. However, they still always have quite specific disadvantages.

For instance, the known free-radically and/or ionically curable coating materials, adhesives, and sealing compounds comprise photoinitiators which when they are exposed to UV radiation form free radicals or cations which initiate the free-radical or ionic polymerization or crosslinking of the constituent (A) (cf. Römpp Lexikon Lacke und Druckfarben, Georg Thieme Verlag, Stuttgart, N.Y. , 1998, “photoinitiators”, pages 444 to 446). A disadvantage here is that the photoinitiators give rise to decomposition products which have an unpleasant odor and/or are colored. This leads to unwanted emissions and to the yellowing of the coatings, adhesives and sealing compounds, which especially in the case of decorative coatings or bonded glass plates is unacceptable. Furthermore, the presence of photoinitiators requires the preparation and application of the coating materials, adhesives, and sealing compounds in the absence of the UV component of visible light, which requires a considerable logistical effort and a considerable expenditure in terms of apparatus. Moreover, the photoinitiators are frequently expensive, and so their use is disadvantageous economically.

A further substantial disadvantage of UV curing is the formation of ozone during irradiation. Ozone, however, is highly toxic and also has the capacity to damage the surface of the coatings, adhesives, and seals. It must therefore be removed under suction, constituting an additional expense in terms of apparatus.

Furthermore, the photopolymerization may be inhibited by atmospheric oxygen, and so either it is necessary to operate in the absence of air or else it is necessary to compensate the inhibition by a very high initiator concentration or by what are known as coinitiators. Despite these measures, it is frequently impossible to realize the surface properties required.

There is therefore a need for a process for producing coatings, adhesive films or seals from free-radically and/or ionically curable coating materials, adhesives or sealing compounds of the type described above which should no longer have the above-described disadvantages but certainly should have its outlined advantages.

The Japanese patent applications JP 08 188 632 A1, 07 228 789 A1, 09 302 262 A1, 01 064 761 A1, 09 052 068 A1, and 08 206 584 A1, and the European patent applications EP 0 774 492 A1 and 0 889 363 A1 disclose free-radically and/or ionically curable coating materials which comprise constituents having photopolymerizable, olefinically unsaturated bonds. These coating materials may be cured using near infrared (NIR) radiation. The prerequisite for this, however, is the use of dyes which absorb NIR radiation and so act as initiators of the photopolymerization. These dyes, however, lead to problems similar to those which occur in the case of conventional photoinitiators. These problems are particularly serious in decorative coatings or clearcoats, or in adhesive films between glass plates. Consequently, the principal application in the case, for example, of the compositions known from the European patent EP 0 889 363 A1 is in the field of the imagewise exposure for the production of photoresists, printing plates or holographic films, where a certain dye content is undisruptive in its effect and even, on the contrary, intensifies the image contrast.

It is an object of the present invention to meet the demand described above and to find a novel process for producing coatings, adhesive films, and seals from existing free-radically and/or ionically curable coating materials, adhesives, and sealing compounds that no longer has the disadvantages of the prior art, such as the odor nuisance and yellowing attributable to the use of photoinitiators, the operation in the absence of the UV component of visible light, and the ozone formation attributable to the use of UV radiation, and which manages without dyes which absorb NIR radiation. At the same time, the novel process ought to continue to have the particular advantages of the known coating materials, adhesives, and sealing compounds, such as a short cycle time, a low energy consumption for curing, and the possibility of coating, bonding, and sealing heat-sensitive substrates.

Accordingly, the novel process for producing coatings, adhesive films or seals for primed or unprimed substrates has been found which comprises

(1) applying at least one free-radically and/or ionically curable coating material and/or adhesive and/or sealing compound comprising at least one constituent (A) containing on average per molecule at least one group (a) containing at least one bond which can be activated with actinic radiation, in the form of

(1.1) a water-free and solvent-free liquid or melt,

(1.2) a powder,

(1.3) a dispersion or a solution in at least one organic solvent, or

(1.4) a dispersion or a solution in an aqueous medium

to and/or into the primed or unprimed substrate,

(2) drying the resultant layer of a dispersion or a solution (1.3) or (1.4) or causing the resultant layer of the melt (1.1) to solidify or maintaining it in a melted state by heating,

(3) melting, by heating, the resultant solid layer (1.2), (1.3) or (1.4), and

(4) curing the liquid layer resulting from step (1) of the process or the melted layer resulting from step (2) or (3) of the process

(4.1) in the liquid or melted state,

(4.2) during solidification, and/or

(4.3) after solidification

with near infrared (NIR) radiation.

In the text below, the novel process for producing coatings, adhesive films or seals for primed or unprimed substrates is referred to as the “process of the invention”.

Further subject matter of the invention will emerge from the description.

In the light of the prior art it was surprising and unforeseeable for the skilled worker that the object on which the present invention is based might be achieved by means of the process of the invention. A particular surprise was that by means of the process of the invention it is possible to subject conventional coating materials, adhesives, and sealing compounds to free-radical and/or ionic crosslinking without the presence of photoinitiators or NIR-absorbing dyes. Even more of a surprise was the extremely broad usefulness of the process of the invention, especially in the field of the coating of primed and unprimed substrates.

The process of the invention serves for the coating, bonding and/or sealing of primed or unprimed substrates.

Suitable substrates are all surfaces of articles that are amenable to curing of the layers of coating materials, adhesives and/or sealing compounds present thereon under application of heat and/or actinic radiation; examples include articles made of metals, plastics, wood, ceramic, stone, textile, fiber composites, leather, glass, glass fibers, glass wool, rock wool, mineral-bound and resin-bound building materials, such as plasterboard, cement slabs, and bricks. Accordingly, the process of the invention is highly suitable for the coating, bonding or sealing of motor vehicle bodies, of furniture, and components for private or industrial use, such as radiators, domestic appliances, small metal parts, hub caps, wheel rims, coils, freight containers, and electrical components, such as windings of electrical motors.

The metallic substrates employed in this context may have a primer system, in particular a cathodically or anodically deposited and heat-cured electrocoat. If desired, the electrocoat may also have been coated with an antistonechip primer or with a primer-surfacer.

The process of the invention is also used in particular for the coating, bonding or sealing of primed or unprimed plastics such as, for example, ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM, and UP (abbreviations to DIN 7728T1). The plastics may of course also be polymer blends, modified plastics, or fiber reinforced plastics. Nonfunctionalized and/or nonpolar plastics surfaces may be subjected prior to coating in a known manner to a pretreatment with a plasma or by flaming and/or may be coated with a water-based primer system comprising a hydroprimer.

In step (1) of the process of the invention, at least one coating material, adhesive and/or sealing compound is applied to and/or into the substrate described above.

The application may take place by any of the customary application methods, such as spraying, knife coating, brushing, flow coating, dipping, impregnating, trickling or rolling, for example. The substrate to be coated, bonded or sealed may itself be at rest, with the application equipment or unit being moved. However, it is also possible for the substrate to be coated, bonded or sealed, in particular a coil, to be moved, with the application unit being at rest relative to the substrate or being moved appropriately.

Preference is given to the use of spray application methods, such as, for example, compressed-air spraying, airless spraying, high-speed rotation, electrostatic spray application (ESTA), alone or in conjunction with hot spray application such as hot-air spraying, for example. Application may take place at temperatures of max. 70 to 80° C., so that appropriate application viscosities are attained without any change or damage to the coating material, adhesive or sealing compound and its overspray (which may be intended for reprocessing) during the short period of thermal stress. Hot spraying, for instance, may be configured in such a way that the coating material, adhesive or sealing compound is heated only very briefly in the spray nozzle or shortly before the spray nozzle.

The spray booth used for application may be operated, for example, with a circulation system, which may be temperature-controllable, and which is operated with an appropriate absorption medium for the overspray, an example of such a medium being the coating material itself that is to be used in accordance with the invention.

The coating material, adhesive and sealing compound may be in the form of a water-free and solvent-free liquid or melt (1.1). In the context of the present invention, a liquid is a substance which is liquid at room temperature. Conversely, a melt is a substance which is solid at room temperature and which liquefies only above room temperature. Coating materials, adhesives and sealing compounds (1.1) of this kind are referred to by those in the art as 100% systems.

The coating material, adhesive or sealing compound may also be in the form of a powder (1.2). Coating materials (1.2) of this kind are conventionally referred to by those in the art as powder coating materials.

Furthermore, the coating materials, adhesives, and sealing compounds may be present in the form of a dispersion or solution in at least one organic solvent (1.3). Coating materials (1.3) of this kind are conventionally referred to by those in the art as conventional coating materials.

Not least, the coating materials, adhesives, and sealing compounds may be present in the form of a dispersion or solution (1.4) in at least one aqueous medium. Coatings of this kind are conventionally referred to by those in the art as aqueous coating materials.

In the context of the present invention, in step (2) of the process the resultant layer of a dispersion or a solution (1.3) or (1.4) is dried.

Where coating materials, adhesives or sealing compounds (1.1) in the form of a melt are used, the resultant layer (1.1) is caused to solidify or is maintained in a melted state by heating. In this case, the layer (1.1) may be heated in a customary and known manner with hot air, in forced-air ovens for example, or with conventional infrared lamps. In accordance with the invention it is of advantage in this step (2) too to use NIR radiation.

Where coating materials, adhesives or sealing compounds (1.2), (1.3) or (1.4) are used, the solid layer (1.2), (1.3) and (1.4) resulting from step (3) is melted by heating. Here again, the layer (1.2), (1.3) or (1.4) may be heated in a customary and known manner with hot air, in forced-air ovens for example, or with conventional infrared lamps. In accordance with the invention it is of advantage in this step (3) too to use NIR radiation.

In step (4) of the process of the invention, the liquid layer (1.1) resulting from step (1) or the melted layer (1.2), (1.3) or (1.4) resulting from step (2) or (3) in a melted state, during solidification and/or after solidification is cured with near infrared (NIR) radiation, the result being the coating materials, adhesives, and seals.

In accordance with the invention it is of advantage to use NIR radiation of a wavelength for which the solid layers (1.2), (1.3) and (1.4), the liquids and melts (1.1), and the melts resulting from step (4) of the process are partially transparent. Particular advantages result if from 20 to 80%, in particular from 40 to 70%, of the irradiated NIR radiation is absorbed. This is preferably achieved by means of NIR radiation of a wavelength of from 600 to 1400 nm, in particular from 750 to 1100 nm, and so it is this which is used with very particular preference for the process of the invention.

Viewed in terms of its method and apparatus, step (4) of the process has no special features but instead takes place with the aid of commercially available lamps which emit a high proportion of their radiation in the near infrared. Examples of suitable lamps are halogen lamps with a high coiled-filament temperature, as sold, for example, by the company Ushio Inc., Tokyo, Japan, or the company IndustrieService, Germany.

In this case, advantageously, using optical devices, the NIR radiation may be guided and focused so as to achieve a temperature distribution which is adapted to the curing characteristics of the coating materials, adhesives, and sealing compounds. Moreover, the radiative energy acting on the applied coating materials, adhesives, and sealing compounds, and/or the wavelength of the NIR radiation, may be precisely adjusted by electrical regulation of the lamps and/or by optical filter devices. For further details, reference is made to the German patent DE 197 36 462 A1, column 1, line 52 to column 2, line 33.

The skilled worker is therefore easily able to determine the parameters advantageous for the case in hand on the basis of his or her knowledge in the art, possibly with the assistance of simple preliminary rangefinding experiments.

The coating materials, adhesives, and sealing compounds to be employed in the process of the invention comprise at least one constituent (A) containing on average per molecule at least one, preferably at least two, group(s) (a) containing at least one bond which can be activated with actinic radiation.

In the context of the present invention, a bond which can be activated with actinic radiation means a bond which, on exposure to actinic radiation, becomes reactive and, with other activated bonds of its kind, enters into polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single bonds or double bonds. Of these bonds, the carbon-carbon double bonds are particularly advantageous and are therefore used with very particular preference in accordance with the invention. For the sake of brevity, they are referred to below as “double bonds”.

Accordingly, the group (a) preferred in accordance with the invention contains one double bond or two, three or four double bonds. Where more than one double bond is used, the double bonds may be conjugated. In accordance with the invention, however, it is of advantage if the double bonds are present in isolation, in particular each terminally, in the group (a). It is of particular advantage in accordance with the invention to use two double bonds, especially one double bond.

The constituent (A) further comprises on average at least one group (a). This means that the functionality of the constituent (A) is integral, i.e., for example, equal to two, three, four, five or more, or nonintegral, i.e., for example, equal to 2.1 to 10.5 or more. Which functionality is chosen depends firstly on the stoichiometric ratios of the starting materials of the constituents (A), which secondly depend in turn on their intended applications.

Where on average more than one group (a) per molecule is employed, the at least two groups (a) are structurally different from one another or of identical structure.

Where they are structurally different from one another, this means in the context of the present invention that two, three, four or more, but especially two, groups (a) are used which derive from two, three, four or more, but especially two, monomer classes.

Examples of suitable groups (a) are (meth)acrylate, ethacrylate, crotonate, cinnamate, vinyl ether, vinyl ester, dicyclopentadienyl, norbornenyl, isoprenyl, isopropenyl, allyl or butenyl groups; dicyclo-pentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups, but especially acrylate groups.

The constituent (A) is preferably a solid, since this results in coating materials, adhesives, and sealing compounds (1.1) or (1.3) which are particularly good for the process of the invention. The solid may be amorphous, partially crystalline, or crystalline. Which variant is used for the process of the invention depends on the requirements of the individual case.

Further particular advantages result if the solvent-free or water-free constituent (A) has a melting range or a melting point in the temperature range from 40 to 130° C. In accordance with the invention it is further of advantage if the solvent-free or water-free constituent (A) has a melt viscosity at 130° C. of from 50 to 20 000 mPas.

The groups (a) are attached to the parent structure of the constituent (A) by way of urethane, urea, allophanate, ester, ether, and/or amide groups. Urethane groups are particularly preferred. The following two linking structures I and II come into consideration for this purpose:

parent structure-NH—C(O)—O-group (a) (I) and

parent structure-O—(O)C—NH-group (a) (II).

The constituent (A) may contain both linking structures I and II, or only one of them. In general, the structure I is of advantage, owing to the larger number of starting materials available and their comparatively greater ease of preparation, and is therefore employed with preference in accordance with the invention.

The groups (a) are attached terminally and/or laterally to the parent structure. Which type of attachment is chosen depends in particular on whether the functional groups are present terminally or laterally in the parent structure with which the starting materials of the groups (a) are able to react. In many cases, terminal groups (a) are more reactive than lateral groups (a), owing to the absence of steric shielding, and are therefore used with preference. On the other hand, however, the reactivity of the solid of the invention may be specifically controlled by way of the ratio of terminal to lateral groups (a), which is a further particular advantage of the solid in accordance with the invention.

The parent structure of the constituent (A) is of low molecular mass, oligomeric and/or polymeric. That is to say that the constituent (A) is a low molecular mass compound, an oligomer or a polymer. Or else the constituent (A) has low molecular mass and oligomeric, low molecular mass and polymeric, oligomeric and polymeric, or low molecular mass, oligomeric, and polymeric parent structures, i.e. it is a mixture of low molecular mass compounds and oligomers, of low molecular mass compounds and polymers, of oligomers and polymers, or of low molecular mass compounds, oligomers, and polymers.

In the context of the present invention, oligomers are resins whose molecule contains at least 2 to 15 repeating monomer units. In the context of the present invention, polymers are resins whose molecule contains at least 10 repeating monomer units. For further details of these terms, reference is made to Römpp, op. cit., “oligomers”, page 425.

The low molecular mass, oligomeric or polymeric parent structure comprises or consists of aromatic, cycloaliphatic and/or aliphatic structures or building blocks. It preferably comprises or consists of cycloaliphatic and/or aliphatic structures, especially cycloaliphatic and aliphatic structures.

Examples of suitable aromatic structures are aromatic and heteroaromatic rings, especially benzene rings.

Examples of cycloaliphatic structures are cyclobutane, cyclopentane, cyclohexane, cycloheptane, norbornane, camphane, cyclooctane or tricyclodecane rings, especially cyclohexane rings.

Examples of aliphatic structures are linear or branched alkyl chains having 2 to 20 carbon atoms, or chains as result from the addition (co)polymerization of olefinically unsaturated monomers.

The parent structure, especially the oligomeric and/or polymeric parent structure, may further comprise olefinically unsaturated double bonds.

The parent structure, especially the oligomeric and/or polymeric parent structure, is of linear, branched, hyperbranched or dendrimeric structure.

It may comprise polyvalent, especially divalent, functional groups by means of which the above-described structures or building blocks are linked with one another to the parent structure. These are generally selected in such a way that they do not disrupt, let alone completely prevent, the reactions initiated by the NIR radiation. Examples of suitable functional groups are ether, thioether, carboxylate, thiocarboxylate, carbonate, thiocarbonate, phosphate, thiophosphate, phosphonate, thiophosphonate, phosphite, thiophosphite, sulfonate, amide, amine, thioamide, phosphoramide, thiophosphoramide, phosphonamide, thiophosphonamide, sulfonamide, imide, urethane, hydrazide, urea, thiourea, carbonyl, thiocarbonyl, sulfone, sulfoxide or siloxane groups. Of these groups, the ether, carboxylate, carbonate, carboxamide, urea, urethane, imide and carbonate groups, especially the carboxylate and the urethane groups, are of advantage and are therefore used with preference.

Advantageous oligomeric and polymeric parent structures are therefore derived from random, alternating and/or block, linear, branched, hyperbranched, dendrimeric and/or comb addition (co)polymers of ethylenically unsaturated monomers, polyaddition resins and/or polycondensation resins. For further details of these terms, reference is made to Römpp, op. cit., page 457, “polyaddition” and “polyaddition resins (polyadducts)”, and also pages 463 and 464, “polycondensates”, “polycondensation”, and “polycondensation resins”.

Examples of highly suitable addition (co)polymers are poly(meth)acrylates and partially saponified polyvinyl esters.

Examples of highly suitable polyaddition resins and/or polycondensation resins are polyesters, alkyds, polyurethanes, polyester-polyurethanes, polylactones, polycarbonates, polyethers, polyester-polyethers, epoxy resin-amine adducts, polyureas, polyamides or polyimides. Of these, the polyesters, polyester-polyethers, polyurethanes and polyester-polyurethanes are particularly advantageous and are therefore used with very particular preference in accordance with the invention.

The parent structure may carry lateral reactive functional groups (b) which with reactive functional groups (b) of their own kind or with other, complementary, functional groups (c) are able to enter into thermally initiated crosslinking reactions. In this case, the complementary functional groups (b) and (c) may be present in one and the same parent structure, which is the case with what are known as self-crosslinking systems. Alternatively, the functional groups (c) may be present in a further constituent, materially different from the solid of the invention, an example of such a constituent being a crosslinking agent (B), which is the case with what are known as externally crosslinking systems. For further details, reference is made to Römpp, op. cit., “Curing”, pages 274 to 276. Reactive functional groups (b) and (c) are used in particular when the constituent (A) is to be curable with NIR radiation and thermally (dual cure). They are selected so that they do not disrupt, let alone entirely prevent, the polymerization or crosslinking reaction of the double bonds of the groups (a) that is initiated by NIR radiation. However, reactive functional groups (b) and (c) which undergo addition onto olefinically unsaturated double bonds may be used as well in minor amounts—that is, amounts which are not disruptive.

Examples of suitable complementary reactive functional groups (b) and (c) are evident from the following overview.

Overview: Complementary Reactive Functional Groups (b) and (c)

| | | |
|---|---|---|
| (b) | and | (c) |
| | or | |
| (c) | and | (b) |
| —SH | | —C(O)—OH |
| —NH₂ | | —C(O)—O—C(O)— |
| —OH | | —NCO |
| —O—(CO)—NH—(CO)—NH₂ | | —NH—C(O)—OR |
| —O—(CO)—NH₂ | | —CH₂—OH |
| | | —CH₂—O—CH₃ |
| | | —NH—C(O)—CH(—C(O)OR)₂ |
| | | —NH—C(O)—CH(—C(O)OR)(—C(O)—R) |
| | | —NH—C(O)—NR¹R² |
| | | ═Si(OR)₂ |
| | | 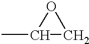 |
| —C(O)—OH | | 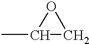 |
| —O—C(O)—CR═CH₂ | | —OH |
| —O—CR═CH₂ | | —NH₂ |
| | | —C(O)—CH₂—C(O)—R |

In the overview, the variable R stands for an acyclic or cyclic aliphatic radical, an aromatic radical and/or an aromatic-aliphatic (araliphatic) radical; the variables R¹ and R² stand for identical or different aliphatic radicals or are linked with one another to form an aliphatic or heteroaliphatic ring.

Where the reactive complementary groups (b) and/or (c) are used, they are preferably present in the constituent (A) in an amount corresponding to an average of from 1 to 4 groups per molecule.

The parent structure may further comprise chemically bonded stabilizers (d). Where they are used too, they are present in the constituent (A) in an amount of from 0.01 to 1.0 mol %, preferably from 0.02 to 0.9 mol %, more preferably from 0.03 to 0.85 mol %, with particular preference from 0.04 to 0.8 mol %, with very particular preference from 0.05 to 0.75 mol %, and in particular from 0.06 to 0.7 mol %, based in each case on the double bonds present in the constituent (A).

The chemically bonded stabilizer (d) comprises compounds which are or which donate sterically hindered nitroxyl radicals (>N—O.) which scavenge free radicals in the modified Denisov cycle.

Examples of suitable chemically bonded stabilizers (d) are HALS compounds, preferably 2,2,6,6-tetraalkyl-piperidine derivatives, especially 2,2,6,6-tetramethyl-piperidine derivatives, whose nitrogen atom is substituted by an oxygen atom or by an alkyl, alkylcarbonyl or alkyl ether group. For further details, reference is made to the textbook “Lackadditive” [Additives for coatings] by Johan Bieleman, Wiley-VCH, Weinheim, N.Y. , 1998, pages 293 to 295.

Examples of suitable starting materials (d) for the introduction of the chemically bonded stabilizers (d) are HALS compounds, preferably 2,2,6,6-tetraalkyl-piperidine derivatives, especially 2,2,6,6-tetramethyl-piperidine derivatives, whose nitrogen atom is substituted by an oxygen atom or by an alkyl, alkylcarbonyl or alkyl ether group, and which contain an isocyanate group or an isocyanate-reactive functional group (b) or (c), in particular a hydroxyl group. One example of an especially suitable starting material (d) is the nitroxyl radical 2,2,6,6-tetramethyl-4-hydroxypiperidine N-oxide.

The preparation of the constituents (A) for use in accordance with the invention has no special features in terms of its method but instead takes place with the aid of the customary and known synthesis methods of low-molecular organic chemistry and/or of polymer chemistry. As regards the oligomeric and/or polymeric constituents (A) which are very particularly preferred in accordance with the invention and which are derived from polyesters, polyester-polyethers, polyurethanes and polyester-polyurethanes, but especially from the polyurethanes and polyester-polyurethanes, the customary and known methods of polyaddition and/or polycondensation are employed. By way of example, reference is made to the above-cited European patents EP 0 928 800 A1, 0 636 669 A1, 0 410 242 A1, 0 783 534 A1, 0 650 978 A1, 0 650 979 A1, 0 650 985 A1, 0 540 884 A1, 0 568 907 A1, 0 054 505 A1, and 0 002 866 A1, the German patents DE 197 09 467 A1, 42 03 278 A1, 33 16 593 A1, 38 36 370 A1, 24 36 186 A1, and 20 03 579 B1, the international patent applications WO 97/46549 and 99/14254, and the American patents U.S. Pat. No. 4,675,234 A1, 4,634,602 A1, 4,424,252 A1, 4,163,810 A1, 4,129,488 A1, and 3,974,303 A1.

The coating materials, adhesives, and sealing compounds used in the process of the invention may further comprise at least one crosslinking agent (B) containing on average per molecule at least two complementary reactive functional groups (c). Examples of suitable crosslinking agents (B) for the thermal curing are amino resins, resins or compounds containing anhydride groups and/or acid groups, resins or compounds containing epoxide groups, tris(alkoxycarbonylamino)-triazines, resins or compounds containing carbonate groups, blocked and/or unblocked polyisocyanates, beta-hydroxyalkylamides, and compounds containing on average at least two groups capable of transesterification, examples being reaction products of malonic diesters and polyisocyanates or of esters and partial esters of polyhydric alcohols of malonic acid with mono-isocyanates, as described in the European patent EP-A-0 596 460. Where particularly reactive cross-linking agents (B) such as polyisocyanates are used, they are generally not added until shortly before the application of the coating materials, adhesives and sealing compounds in question, which in that case are referred to by those in the art as two-component systems. Systems known as one-component systems result if less reactive crosslinking agents (B) are present from the outset in the coating materials, adhesives, and sealing compounds. The nature and amount of the crosslinking agents (B) are guided primarily by the complementary reactive groups (b) present in the constituents (A) and by the number of these groups.

The coating materials, adhesives, and sealing compounds used in the process of the invention may further comprise, moreover, at least one additive (C) selected from the group consisting of color and/or effect pigments, organic and inorganic, transparent or opaque fillers, nanoparticles, reactive diluents curable thermally and/or with actinic radiation, low-boiling and high-boiling organic solvents (“long solvents”), UV absorbers, light stabilizers, free-radical scavengers, thermolabile free-radical initiators, thermal crosslinking catalysts, devolatilizers, slip additives, polymerization inhibitors, defoamers, emulsifiers, wetting agents, dispersants, adhesion promoters, leveling agents, film-forming auxiliaries, sag control agents (SCAs), rheology control additives (thickeners), flame retardants, siccatives, driers, antiskinning agents, corrosion inhibitors, waxes, and flatting agents.

The nature and amount of the additives (C) are guided by the intended use of the coatings, adhesive films, and seals produced with the aid of the process of the invention.

Where, for example, the process of the invention is used to produce solid-color topcoats or basecoats, the coating material in question comprises color and/or effect pigments (C) and also, if desired, opaque fillers. Where the process of the invention is used, for example, to produce clearcoats, these additives (C) are of course not present in the coating material in question.

Examples of suitable effect pigments (C) are metal flake pigments such as commercially customary aluminum bronzes, aluminum bronzes chromated in accordance with DE-A-36 36 183, and commercially customary stainless steel bronzes, and also nonmetallic effect pigments, such as pearlescent pigment and interference pigment, for example. For further details, reference is made to Rompp, op. cit., page 176, “effect pigments” and pages 380 and 381, “metal oxide-mica pigments” to “metal pigments”.

Examples of suitable inorganic color pigments (C) are titanium dioxide, iron oxides, Sicotrans yellow, and carbon black. Examples of suitable organic color pigments (C) are thioindigo pigments, indanthrene blue, Cromophthal red, Irgazine orange, and Heliogen green. For further details, reference is made to Römpp, op. cit., pages 180 and 181, “iron blue pigments” to “black iron oxide”, pages 451 to 453, “pigments” to “pigment volume concentration”, page 563, “thioindigo pigments”, and page 567, “titanium dioxide pigments”.

Examples of suitable organic and inorganic fillers (C) are chalk, calcium sulfates, barium sulfate, silicates such as talc or kaolin, silicas, oxides such as aluminum hydroxide or magnesium hydroxide, or organic fillers such as textile fibers, cellulose fibers, polyethylene fibers, or wood flour. For further details, reference is made to Römpp, op. cit., pages 250 ff, “fillers”.

Examples of suitable thermally curable reactive diluents (C) are positionally isomeric diethyl-octanediols or hydroxyl-containing hyperbranched compounds or dendrimers.

Examples of suitable reactive diluents (C) curable with actinic radiation are those described in Römpp, op. cit., on page 491 under the entry on “reactive diluents”.

Examples of suitable low-boiling organic solvents (C) and high-boiling organic solvents (C) (“long solvents”) are ketones such as methyl ethyl ketone or methyl isobutyl ketone, esters such as ethyl acetate or butyl acetate, ethers such as dibutyl ether or ethylene glycol, diethylene glycol, propylene glycol, dipropylene glycol, butylene glycol or dibutylene glycol dimethyl, diethyl or dibutyl ethers, N-methylpyrrolidone or xylenes, or mixtures of aromatic hydrocarbons such as Solvent Naphtha® or Solvesso®.

Examples of suitable light stabilizers (C) are HALS compounds, benzotriazoles or oxalanilides. Examples of suitable thermolabile free-radical initiators (C) are organic peroxides, organic azo compounds or C—C-cleaving initiators such as dialkyl peroxides, peroxocarboxylic acids, peroxodicarbonates, peroxide esters, hydroperoxides, ketone peroxides, azo dinitriles or benzpinacol silyl ethers.

Examples of suitable crosslinking catalysts (C) are dibutyltin dilaurate, lithium decanoate or zinc octoate.

Examples of suitable devolatilizers or degasifiers (C) are diazadicycloundecane or benzoin.

Examples of suitable emulsifiers (C) are nonionic emulsifiers, such as alkoxylated alkanols and polyols, phenols and alkylphenols, or anionic emulsifiers such as alkali metal salts or ammonium salts of alkanecarboxylic acids, alkanesulfonic acids, and sulfo acids of alkoxylated alkanols and polyols, phenols and alkylphenols.

Examples of suitable wetting agents (C) are siloxanes, fluorine compounds, carboxylic monoesters, phosphates, polyacrylic acids and their copolymers, or polyurethanes.

An example of a suitable adhesion promoter (C) is tricyclodecanedimethanol.

Examples of suitable film-forming auxiliaries (C) are cellulose derivatives.

Examples of suitable transparent fillers (C) are those based on silica, alumina or zirconium oxide; for further details, reference is made to Römpp, op. cit., pages 250 to 252.

Examples of suitable Sag control agents (C) are ureas, modified ureas and/or silicas, as described for example in the references EP-A-192 304, DE-A-23 59 923, DE-A-18 05 693, WO 94/22968, DE-C-27 51 761, WO 97/12945 or “farbe+lack”, 11/1992, pages 829 ff.

Examples of suitable rheology control additives (C) are those known from the patents WO 94/22968, EP-A-0 276 501, EP-A-0 249 201 or WO 97/12945; crosslinked polymeric microparticles, as disclosed for example in EP-A-0 08 127; inorganic phyllosilicates such as aluminum magnesium silicates, sodium magnesium and sodium magnesium fluorine lithium phyllosilicates of the montmorillonite type; silicas such as Aerosils; or synthetic polymers containing ionic and/or associative groups, such as polyvinyl alcohol, poly(meth)acrylamide, poly(meth)acrylic acid, poly-vinylpyrrolidone, styrene-maleic anhydride or ethylene-maleic anhydride copolymers and their derivatives or hydrophobically modified ethoxylated urethanes or polyacrylates.

An example of a suitable flatting agent (C) is magnesium stearate.

Further examples of the above-recited additives (C) and also examples of suitable UV absorbers, free-radical scavengers, leveling agents, flame retardants, siccatives, driers, antiskinning agents, corrosion inhibitors and waxes (C) are described in detail in the textbook “Lackadditive” by Johan Bieleman, Wiley-VCH, Weinheim, N.Y. , 1998.

The additives (C) are used in customary and known, effective amounts.

The preparation of the coating materials, adhesives, and sealing compounds has no special features but instead takes place in a customary and known manner by mixing of the above-described constituents (A) and also, if desired, (B) and (C) in suitable mixing equipment such as stirred vessels, dissolvers, stirred mills or extruders in accordance with the techniques which are suitable for the preparation of the respective coating materials, adhesives, and sealing compounds (1.1), (1.2), (1.3) or (1.4).

The coatings produced by means of the process of the invention, especially the single-coat and multicoat clearcoats and color and/or effect coatings, are of the very highest optical quality as regards color, effect, gloss, and DOI (distinctiveness of the reflected image), have a smooth, structureless, hard, flexible, and scratch-resistant surface, are free of odor and resistant to weathering, chemicals and etching, do not yellow, and display no cracking or delamination of the coats.

The adhesive films and seals produced by means of the process of the invention are long-lived, even under extreme climatic conditions, and are of high bond strength and sealing capacity, respectively.

The primed or unprimed substrates which have been provided by the procedure of the invention with at least one coating, adhesive film and/or seal therefore have a particularly long service life and a particularly high utility, making them especially attractive both technically and economically to manufacturers, applicators and end users.

### EXAMPLES AND COMPARATIVE EXPERIMENTS

### Preparation Example 1

The Preparation of a Free-Radically Curable Polyester (A)

A stirred flask with heating and reflux condenser was charged with:

| | |
|---|---|
| 661.10 g of dicyclopentadiene | (5.0 mol) and |
| 490.30 g of maleic anydride | (5.0 mol). |

The mixture was heated to 125° C. under a gentle stream of nitrogen. Subsequently

| | |
|---|---|
| 95.00 g of water | (5.0 mol + 5 g) |

were added through a dropping funnel over the course of one hour. Reaction was allowed to continue at 125° C. for one hour. The monocarboxylic acid of the formula:

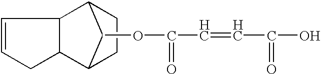

was formed.

A further stirred flask with heating and top-mounted distillation attachment was charged with:

| | | |
|---|---|---|
| 240.00 | g of dicyclohexanolpropane | (1 mol), |
| 236.00 | g of hexane-1,6-diol | (2 mol), |
| 194.00 | g of dimethyl terephthalate | (1 mol) and |
| 0.67 | g of tin acetate. | |

This initial charge was heated rapidly to 120° C. under a gentle stream of nitrogen. The temperature was then raised gradually to 190° C. over the course of 3 hours, during which the water of condensation formed was removed by distillation. This gave precursor 1.

The monocarboxylic acid was cooled to 90° C. and then the following were added:

| | | |
|---|---|---|
| 516.80 | g of precursor 1 | (2 mol), |
| 116.00 | g of fumaric acid | (1 mol), |
| 4.00 | g of dibutyltin dilaurate and | |
| 0.50 | g of hydroquinone. | |

The mixture was heated rapidly to 130° C. under a gentle stream of nitrogen. Then the temperature was raised gradually to 190° C. over the course of 6 hours, during which the water of condensation formed was removed by distillation.

This gave the polyester (A) having an acid number of 17, which solidified on cooling and, after grinding, gave noncaking powders.

### Preparation Example 2

The Preparation of a Free-Radically Curable Polyurethane (A)

A suitable reaction vessel equipped with stirrer, reflux condenser, heating and inert gas supply was charged with

14.76 g of trimethylolpropane,

236.36 g of hexane-1,6-diol,

197.2 g of hydroxyethyl acrylate and

0.56 g of 2,2,6,6-tetramethyl-4-hydroxypiperidine N-oxide

and this initial charge was heated to 60° C. 666 g of isophorone diisocyanate (IPDI) and 1.1 g of dibutyltin dilaurate were metered into the initial charge over the course of one hour. As a result of the exothermic reaction, the temperature rose slowly to 100° C. The resulting reaction mixture was left to react at 100° C. for 30 minutes more, so that free isocyanate groups were no longer detectable. The melt was poured out onto an aluminum foil and left to cool. This gave a hard, readily grindable resin.

### Preparation Example 3

The Preparation of a Free-Radically Curable Polyurethane (A)

Preparation Example 2 was repeated but using the following starting products instead of the starting products used there:

| | | |
|---|---|---|
| Initial charge: | 62 | g of ethylene glycol (1 mol), |
| | 45 | g of butane-1,4-diol (0.5 mol), |
| | 232 | g of hydroxyethyl acrylate |
| | | (2 mol) and |
| | 0.4 | g of 2,2,6,6-tetramethyl- |
| | | 4-hydroxypiperidine N-oxide. |
| Feed stream: | 420.5 | g of hexamethylene diisocyanate |
| | | (2.5 mol) and |
| | 1 | g of dibutyltin dilaurate. |

This gave a hard, opaque (crystalline) resin with blocking resistance.

### Examples 1 to 3 and Comparative Experiments C1 to C4

The Production of Coatings by the Process of the Invention (Examples 1 to 3) and by a Noninventive Process (Comparative Experiments C1 to C4)

For Example 1 and Comparative Experiment C1 the resin from Preparation Example 1 was used.

For Example 2 and Comparative Experiment C2 the resin from Preparation Example 2 was used.

For Example 3 and Comparative Experiments C3 and C4 the resin from Preparation Example 3 was used.

The resins were coarsely ground in a hammer mill to a fine grit and following the addition of—based on the resulting coating material—1.0% by weight of benzoin (devolatilized), 0.5% by weight of a commercial leveling agent (Modaflow® 3) and 3% by weight of dicumyl peroxide, grinding was continued. The ground material in each case was then homogenized in a laboratory extruder at about 80° C., discharged onto aluminum foil, homogenized again by grinding, and then sieved to a particle size of max. 40 μm. Using a manual sieve, the resulting powder coating materials 1, 2 and 3 were scattered onto birch plywood which had been placed on a balance, in an amount sufficient to produce coating films approximately 100 μm thick.

In Examples 1 to 3, the melting and curing of the resulting powder coating films 1, 2 and 3 were carried out by means of an NIR unit from IndustrieService. Table 1 gives an overview of the curing conditions and curing times employed and of the results obtained in these examples.

In the case of Comparative Experiments C1 to C4, the melting and curing of the powder coating films 1, 2 and 3 were carried out with the aid of a conventional longwave infrared lamp (Elstein dark emitter with an emission maximum at about 7 000 nm). For the purpose of temperature regulation, in Comparative Experiments C1 to C3 the infrared lamp was at a distance of between 80 and 120 cm from the surface of the powder coating films. In Comparative Experiment C4 it was at a distance of 22 cm therefrom. Table 2 gives an overview of the curing conditions and curing times employed and of the results obtained in these experiments.

The results of Tables 1 and 2 demonstrate that under the longwave infrared lamp (Comparative Experiments C1 to C4) it was not possible to set curing conditions under which the powder coating films were crosslinked effectively right through (MEK test: sat.) without the wood beginning to emit gas, resulting in bubbly coatings. Heating therefore had to be carried out at lower energy, i.e., with a large distance between lamp and substrate, in order to prevent overheating. In the course of the comparatively long heating times which this resulted in, unwanted gelling of the melting powder coating films set in. Consequently, they did not attain an advantageously low melt viscosity prior to their crosslinking, and so coatings with poor leveling and a pronounced orange peel structure were the result. By means of the process of the invention (Examples 1 to 3) it was possible to remove these disadvantages entirely, and this resulted in coatings with very good through-crosslinking, very good leveling, and excellent optical properties.

TABLE 1
The production of coatings inventively and
the properties of the resulting coatings

| | | | | | Surface | MEK |
|---|---|---|---|---|---|---|
| | Melt- | Surface | | Wood | smooth- | resis- |
| | ing | tempe- | Holding | out- | ness | tance |
| Ex- | time | rature | time | gassing | sat./ | sat./ |
| ample | (s) | (° C.) | (s) | Yes/No | unsat. | unsat. |
| 1 | 10 | 145 | 60 | No | sat. | almost |
| | | | | | | sat. |
| | 10 | 145 | 90 | No | sat. | sat. |
| | 10 | 160 | 60 | No | sat. | sat. |
| 2 | 10 | 145 | 30 | No | sat. | almost |
| | | | | | | sat. |
| | 10 | 145 | 45 | No | sat. | sat. |
| 3 | 10 | 145 | 30 | No | sat. | almost |
| | | | | | | sat. |
| | 10 | 145 | 45 | No | sat. | sat. |

| | | |
|---|---|---|
| MEK resistance: | sat. = | no damage to the coating after |
| | | 50 double strokes with a cotton |
| | | pad soaked with methyl ethyl |
| | | ketone; |
| | unsat. = | distinct damage to the coating |
| | | after 50 double strokes with a |
| | | cotton pad soaked with methyl |
| | | ethyl ketone; |
| Surface smoothness: | sat. = | no orange peel structures |
| | | visible; |
| | unsat. = | pronounced orange peel |
| | | structure; |

TABLE 2
The production of coatings noninventively and
the properties of the resulting coatings

| | | | | | Surface | MEK |
|---|---|---|---|---|---|---|
| Compara- | Melt- | Surface | Hold- | Wood | smooth- | resis- |
| tive | ing | tempe- | ing | out- | ness | tance |
| experi- | time | rature | time | gassing | sat./ | sat./ |
| ment | (s) | (° C.) | (s) | Yes/No | unsat. | unsat. |
| C1 | 240 | 145 | 120 | Yes,m | unsat.,sb | unsat. |
| | 240 | 145 | 240 | Yes,s | unsat.,b | unsat. |
| | 240 | 145 | 300 | Yes,ss | unsat.,vb | sat. |
| | 180 | 160 | 180 | Yes,ss | unsat.,vb | sat. |
| | 300 | 135 | 300 | Yes,ms | unsat.,b | unsat. |
| | 300 | 135 | 420 | Yes,s | unsat.,vb | sat. |
| C2 | 240 | 145 | 90 | Yes,m | unsat.,sb | almost sat. |
| | 240 | 145 | 120 | Yes,s | unsat.,b | sat. |
| | 300 | 125 | 120 | Yes,m | unsat.,sb | unsat. |
| | 300 | 125 | 240 | Yes,ms | unsat.,b | almost sat. |
| V3 | 240 | 145 | 90 | Yes,m | unsat.,sb | almost sat. |
| | 240 | 145 | 120 | Yes,s | unsat.,b | sat. |
| | 300 | 125 | 120 | Yes,m | unsat.,sb | unsat. |
| | 300 | 125 | 240 | Yes,ms | unsat. | almost sat. |
| C4 | 35^{a)} | 174^{b)} | 30 | Yes,m | unsat.,sb | unsat.^{c)} |
| | 35^{a)} | 188^{b)} | 90 | Yes,s | unsat.,vb | sat.^{c)} |
| | 35^{a)} | 201^{b)} | 120 | Yes,ss | unsat.,vb | sat.^{c)} |

| | | |
|---|---|---|
| MEK resistance: | sat. = | no damage to the coating |
| | | after 50 double strokes with |
| | | a cotton pad soaked with |
| | | methyl ethyl ketone; |
| | unsat. = | distinct damage to the |
| | | coating after 50 double |
| | | strokes with a cotton pad |
| | | soaked with methyl ethyl |
| | | ketone; |
| Surface smoothness: | sat. = | no orange peel |
| | | structures visible; |
| | unsat. = | pronounced orange peel |
| | | structure; |
| | sb = | slightly blistery; |
| | b = | blistery; |
| | vb = | very blistery; |
| Wood outgassing: | m = | moderate; |
| | ms = | moderately severe; |
| | s = | severe; |
| | ss = | very severe; |

^{a)}= melting temperature: 145° C.
^{b)}= final temperature;
^{c)}= nonuniform through-curing over the film surface,
surface in some places with yellowish brownish
discoloration;

What is claimed is:

1. A process for producing coatings, adhesive films or seals for primed or unprimed substrates, which comprises
(1) applying at least one free-radically and/or ionically curable coating material and/or adhesive and/or sealing compound comprising at least one constituent (A) containing on average per molecule at least one group (a) containing at least one bond which can be activated with actinic radiation, in the form of
(1.1) a water-free and solvent-free liquid or melt,
(1.2) a powder,
(1.3) a dispersion or a solution in at least one organic solvent, or
(1.4) a dispersion or a solution in an aqueous medium
to and/or into the primed or unprimed substrate,
(2) drying the resultant layer of a dispersion or a solution (1.3) or (1.4) or causing the resultant layer of the melt (1.1) to solidify or maintaining it in a melted state by heating,
(3) melting, by heating, the resultant solid layer (1.2), (1.3) or (1.4), and
(4) curing the liquid layer resulting from step (1) of the process or the melted layer resulting from step (2) or (3)of the process
(4.1) in the liquid or melted state,
(4.2) during solidification, and/or
(4.3) after solidification
with near infrared (NIR) radiation.

2. The process as claimed in claim 1, wherein the heating in step (2) is carried out with the aid of NIR radiation.

3. The process as claimed in claim 1 or 2, wherein the heating in step (3) is carried out with the aid of NIR radiation.

4. The process as claimed in any of claims 1 to 3, using NIR radiation of a wavelength for which the solid layers (1.2), (1.3) and (1.4), the liquids and melts (1.1), and the melts resulting from step (4) are partly transparent.

5. The process as claimed in claim 4, wherein the solid layers (1.2), (1.3) and (1.4), the liquids and melts (1.1), and the melts resulting from step (4) absorb from 20 to 80% of the irradiated NIR radiation.

6. The process as claimed in claim 4 or 5, wherein the NIR radiation has a wavelength of from 600 to 1400 nm.

7. The process as claimed in any of claims 1 to 6, wherein the bonds which can be activated with actinic radiation comprise carbon-hydrogen single bonds or carbon-carbon, carbon-oxygen, carbon-nitrogen, carbon-phosphorus or carbon-silicon single bonds or double bonds.

8. The process as claimed in claim 7, wherein the bonds are carbon-carbon double bonds.

9. The process as claimed in claim 8, wherein (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups are used.

10. The process as claimed in claim 9, wherein acrylate groups are used.

11. The process as claimed in any of claims 1 to 10, wherein the constituent (A) is a solid.

12. The process as claimed in claim 11, wherein the constituent (A) is amorphous, partially crystalline, or crystalline.

13. The process as claimed in claim 13, wherein the parent structure of the constituent (A) is of low molecular mass, oligomeric and/or polymeric.

14. The process as claimed in claim 13, wherein the oligomeric and/or polymeric parent structure of the constituent (A) comprises olefinically unsaturated double bonds.

15. The process as claimed in claim 13 or 14, wherein the oligomeric and/or polymeric parent structure of the constituent (A) is derived from random, alternating and/or block, linear, branched, hyperbranched, dendrimeric and/or comb poly-addition resins, polycondensation resins and/or addition (co)polymers of ethylenically unsaturated monomers.

16. The process as claimed in claim 15, wherein the addition (co)polymers are poly(meth)acrylates and/or partially saponified polyvinyl esters and the polyaddition resins and/or polycondensation resins are polyesters, alkyds, polyurethanes, polyester-polyurethanes, polylactones, poly-carbonates, polyethers, polyester-polyethers, epoxy resin-amine adducts, polyureas, polyamides or polyimides, especially polyesters, polyester-polyethers, polyurethanes, and polyester-polyurethanes.

17. The process as claimed in any of claims 1 to 16, wherein the groups (a) in the compound (A) are attached to the parent structure by way of urethane, urea, allophanate, ester, ether, and/or amide groups.

18. The process as claimed in claim 17, wherein the groups (a) in the constituent (A) are attached to the parent structure by way of urethane groups.

19. The process as claimed in any of claims 1 to 18, wherein the constituent (A) further comprises at least one reactive functional group (b) which with groups (b) of its own kind and/or with complementary reactive functional groups (c) is able to enter into thermal crosslinking reactions.

20. The process as claimed in any of claims 1 to 19, wherein the constituent (A) further comprises at least one chemically bonded stabilizer (d).

21. The process as claimed in claim 20,wherein a HALS compound is used as chemically bonded stabilizer (d).

22. The process as claimed in claim 21, wherein the 2,2,6,6-tetramethylpiperidine N-oxide-4-oxy group is used as chemically bonded HALS compound (d).

23. The process as claimed in any of claims 1 to 22, wherein the coating material, the adhesive or the sealing compound comprises at least one crosslinking agent (B) containing on average per molecule at least two complementary reactive functional groups (c).

24. The process as claimed in any of claims 1 to 23, wherein the coating material, the adhesive or the sealing compound comprises at least one additive (C).

25. The process as claimed in any of claims 1 to 24, wherein the solvent-free or water-free constituent (A) has a melting range or a melting point in the temperature range from 40 to 130° C.

26. The process as claimed in any of claims 1 to 25, wherein the solvent-free or water-free constituent (A) has a melt viscosity at 130° C. of from 50 to 20 000 mPas.

27. A primed or unprimed substrate comprising at least one coating, at least one adhesive film and/or at least one seal which can be produced by the process as claimed in any of claims 1 to 26.

28. The primed or unprimed substrate as claimed in claim 27, selected from motor vehicle bodies, furniture or industrial components, including coils, containers, and electrical components.
